(19) United States
(12) Patent Application Publication
(10) Pub. No.: US 2014/0265231 A1
(43) Pub. Date: Sep. 18, 2014

(54) BICYCLE WITH COMPLIANT REAR STRUCTURE

(71) Applicant: Specialized Bicycle Components, Inc., Morgan Hills, CA (US)

(72) Inventors: Christopher P. D'Aluisio, Corralitos, CA (US); Samuel Pickman, Aptos, CA (US); Christopher M. Meertens, Morgan Hill, CA (US)

(21) Appl. No.: 14/209,542

(22) Filed: Mar. 13, 2014

Related U.S. Application Data
(60) Provisional application No. 61/790,230, filed on Mar. 15, 2013.

(51) Int. Cl. B62K 25/04

(52) U.S. Cl. CPC B62K 25/04
USPC 280/284

(57) ABSTRACT

The present invention provides a bicycle comprising wheels and a frame supported on the wheels. The frame includes a seatstay assembly defining a seatstay axis and including a spring assembly having a spring member (e.g., a leaf spring) at an angle of at least 5 degrees relative to the seatstay axis. The spring member has a width that is at least 4 times larger than its thickness. The present invention also provides a bicycle comprising a frame that includes a seat tube and a seatstay assembly defining a seatstay axis. The seatstay assembly includes a spring member offset from the seatstay axis and non-parallel to the seatstay axis. In one embodiment, the seatstay assembly further includes a seatstay tube, and the spring member includes a rear portion secured to the seastay tube. The spring member can also include a front portion secured to a seat tube of the bicycle frame.

### BACKGROUND

The present invention relates generally to the field of bicycles and specifically to the rear structure of bicycle frames.

Many bicycles have rigid frames that provide little shock absorbing capabilities and instead rely on pneumatic tires to smooth out the bumps on the riding surface. Mountain bikes are specifically designed for off-road riding and are often equipped with front and/or rear shock absorbers to cushion impact on the wheels. These shock absorbers typically have spring-biased and damped telescoping members that will absorb impacts on the wheels.

Bicycle shock absorbers can be heavy and can also have a considerable amount of unsprung weight. Both of these features can be a significant disadvantage on a road bicycle, for which light weight and precise handling are considered very important.

### SUMMARY

The present invention provides a bicycle is comprising front and rear wheels and a frame supported on the front and rear wheels. The frame includes a seatstay assembly defining a seatstay axis, and the seatstay assembly includes a spring assembly having a spring member (e.g., a leaf spring) oriented at an angle of at least 5 degrees relative to the seatstay axis. The angle is preferably 10-130 degrees and more preferably 10-80 degrees. In one embodiment, the spring member includes a rear portion positioned lower than a front portion.

The front portion of the spring assembly is preferably secured to a seat tube of the bicycle frame. For example, the front portion of the spring assembly can includes a concave surface receiving a portion of the seat tube.

In one embodiment, the spring member has a width (in a lateral direction) that is at least 4 times larger than its thickness (perpendicular to the lateral direction and generally perpendicular to a spring axis). Preferably the width is at least 7 times, and more preferably about 10 times, larger than the thickness.

In another aspect, the present invention provides a bicycle comprising front and rear wheels and a frame supported on the front and rear wheels. The frame includes a seat tube and a seatstay assembly defining a seatstay axis. The seatstay assembly includes a spring member (e.g., a leaf spring) offset from the seatstay axis and non-parallel to the seatstay axis. In one embodiment, the seatstay assembly further includes a seatstay tube, and the spring member includes a rear portion secured to the seastay tube. The spring member can also include a front portion secured to a seat tube of the bicycle frame. Preferably, the front portion is higher than the rear portion. In addition, it is preferred to have the rear portion offset from the seastay axis.

Other aspects of the invention will become apparent by consideration of the detailed description and accompanying drawings.

### BRIEF DESCRIPTION OF THE DRAWINGS

FIG. 1 is a side view of a bicycle having a bicycle frame embodying the present invention.

FIG. 2 is a rear view of the bicycle frame of FIG. 1.

FIG. 3 is a rear perspective view of a portion of the bicycle of FIG. 1 with the rear wheel removed.

FIG. 4 is an enlarged side view of a portion of the bicycle frame of FIG. 1.

FIG. 5 is an exploded side view of the bicycle frame in FIG. 1.

FIG. 6 is an exploded perspective view of a portion of the bicycle frame in FIG. 1.

FIG. 7 is a perspective section view taken along line 7-7 in FIG. 2.

FIG. 8 is a perspective section view taken along line 8-8 in FIG. 5.

FIG. 9 is a side view of an elastomer from FIG. 1.

FIG. 10 is a front perspective view of the elastomer of FIG. 9.

FIG. 11 is a rear perspective view of the elastomer of FIG. 9.

FIG. 12 is a rear perspective view illustrating a portion of a bicycle frame that is a second embodiment of the present invention.

FIG. 13 is a front perspective view of the bicycle frame of FIG. 12.

FIG. 14 is an exploded view of the bicycle frame of FIG. 12.

FIG. 15 is a side view of the bicycle frame of FIG. 12.

FIG. 16 is a view taken parallel to the seat tube axis of the bicycle frame of FIG. 12.

FIG. 17 is a bottom view of the bicycle frame of FIG. 12.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

FIGS. 1-5 illustrates a bicycle 20 having front and rear wheels 22, a frame 24 including a fork 26 supported by the wheels 22, and a crank mechanism 28 for inputting power to the bicycle. The bicycle 20 further includes handlebars 27 for steering the front wheel 22 and a seat 29. The front portion of the frame 24 includes a top tube 30, head tube 32, down tube 34, and a seat tube 36. The rear portion of the frame 24 includes chain stays 38, a seatstay assembly 40, and rear dropouts 42 connecting the chain stays 38 to the seatstay assembly 40. A bottom bracket 44 connects the down tube 34, seat tube 36, and chain stays 38, and also supports the crank mechanism 28. The seat state assembly 40 includes seatstay tubes 46 extending upwardly from the rear dropouts 42, a seatstay crown 48 connected to the upper end of the seatstay tubes 46, and a spring member 50 connecting the upper end of the seatstay crown 48 to the seat tube 36.

The spring member 50 extends approximately at a right angle from an upper end of the seatstay crown 48. In this regard, the spring member 50 acts as a cantilevered leaf spring and includes a rear portion 51 positioned higher than a front portion 56. The end of the spring member 50 adjacent to the seatstay crown 48 has a vertical thickness T (FIG. 4) that is substantially smaller than its width W (FIG. 6) at the same location, thereby creating a structure that is more compliant when flexing about a horizontal axis 52 (lateral to the longitudinal extent of the frame) than when flexing about a vertical axis 54 (FIG. 3). From the location where it attaches to the crown 48, the spring member angles forward and downward toward the down tube 34 until it intersects with the seat tube 36 at the front portion or lower attachment location 56. At this lower attachment location 56, the spring member is secured to the seat tube 36.

Referring to FIGS. 6 and 8, the lower portion of the spring member 50 has a convex surface 58 facing away from the seat tube 36 and a concave surface 60 facing toward the seat tube 36. The concave surface 60 substantially matches the outer contour of the seat tube 36 such that the two parts fit together at the lower attachment location 56.

Referring to FIG. 4, the spring member 50 has a longitudinal extent that defines a spring axis 62 that is positioned at a spring-seat tube angle α relative to the seat tube 36. In the illustrated embodiment, the spring-seat tube angle α is about 24 degrees. The spring axis 62 is also positioned at a spring-seatstay angle β relative to the seatstays. For purposes of this angle, we determine the seatstay axis 64 by a line passing through the rear wheel axle 66 and through an intersection of the spring member 50 with the seatstay crown 48. In the illustrated embodiment, this spring-seatstay angle β is about 75 degrees.

It will be readily apparent that the above-described structure facilitates a small amount of flexibility in the seatstay assembly 40. This flexibility is provided primarily by the spring member 50 positioned substantially perpendicular to the seatstays. In this regard, the spring member 50 acts as a leaf spring for the seatstay assembly 40. In its preferred embodiment, the structural elements of the frame are designed to provide about 2 mm-4 mm of vertical travel of the rear dropouts 42 (e.g., relative to the seat tube 36) when riding on the expected road surface.

The seatstay assembly 40 further includes a resilient member 70 positioned in a gap 72 defined between the spring member 50 and the seat tube 36 above the lower attachment location 56. The resilient member 70 provides additional resistance to upward movement of the seatstay assembly 40, and is further believed to dampen vibration coming from the rear wheel.

The resilient member 70 is shaped fit in the gap 72. Referring to FIGS. 9-11, the resilient member 70 includes a concave front surface 74 dimensioned to receive the outer rear surface of the seat tube 36. The resilient member 70 further includes a convex rear surface 76 dimensioned to fit into the concave surface 60 of the spring member 50. The front surface 74 and rear surface 76 of the resilient member 70 merge to define an arcuate edge 78 on the lower end of the resilient member 70.

In a preferred embodiment, the resilient member 70 is secured in the gap 72 using an adhesive. Alternatively, the resilient member 70 can be secured in the gap 72 using any suitable means, such as fasteners, mechanical engagement, co-molding, or any other appropriate means. If desired, the resilient member 70 can be secured in the gap by a releasable of means, such as releasable adhesive or removable fasteners, to thereby facilitate replacement of the resilient member 70. Such replacement of the resilient member 70 would be is desirable in the event that the resilient member 70 becomes damaged or wears out, or in the event that it is desired to adjust the stiffness of the seatstay assembly 40. For example, if it is desired to reduce the amount of vertical travel of the rear dropouts 42, the resilient member 70 can be replaced with a stiffer resilient member, thereby increasing the resistance to flexing of the spring member 50.

A second embodiment of the present invention is illustrated in FIGS. 12-17 and can be used on the bicycle of FIG. 1. The illustrated frame includes a seat tube 80, two seatstays 82, and a seatstay bridge 84 connecting the two seatstays 82. An upper end of each seatstay 82 includes a gap 86 that allows upward movement of the lower portion of the seatstays 82 relative to the seat tube 80.

The second embodiment further includes a spring assembly 88 that provides resilient support between the seatstays 82 and the seat tube 80. The spring assembly 88 includes a front mount 90 secured to the seat tube 80, two spring members 92 secured to the front mount 90, and two rear mounts 94 secured between a corresponding spring member 92 and a corresponding seatstay 82. In the illustrated embodiment, the front mount 90 is formed separate from the spring members 92, and each spring member 92 is formed integrally with a corresponding rear mount 94. However, other arrangements are possible and fall within the scope of the present invention.

Referring to FIG. 14, the front mount 90 includes a front pad 96 and a front slot 98. The front pad 96 is adapted to facilitate attachment to the seat tube 80 (e.g., by bonding, welding, brazing, fastening, etc.). The front pad 96 is shaped to match the contour of the seat tube 80 in order to enhance the connection. The front slot 98 dimensioned to receive the spring members 92. The front slot 98 is oriented with an open end facing substantially parallel to a longitudinal axis 99 of the seat tube 80. The front mount 90 can be made of any suitable material, such as steel, aluminum, titanium, or reinforced composite (e.g., carbon, glass, or aramid fibers in an epoxy matrix).

Each spring member 92 includes a front portion 100, a middle portion 102, and a rear portion 104. The front portion 100 is oriented substantially parallel to the seat tube axis 99 and is dimensioned to fit surely into the front slot 98 of the front mount and can be secured in place by any appropriate means (e.g., by bonding, welding, brazing, fastening, etc.). The rear portion 104 is secured to the corresponding rear mount 94 (in the illustrated embodiment, these two parts are integrally formed). As shown in FIG. 15, the rear portion 104 defines an axis 105 that is positioned at a rear angle γ relative to the seatstay axis 107 and also provides a spacing S between the seatstay axis 107 and the rear end of the middle portion 102 of the spring member 92. The rear angle γ of the illustrated embodiment is about 107 degrees, and the spacing S is greater than the side thickness T1 of the seatstay 82 at that location.

In order to increase the vertical stiffness of the spring assembly 88, a resilient cushion 106 (FIG. 14) can be inserted into the gap 86 of each seatstay 82. If desired, the cushion 106 can be designed to be removable so that the stiffness of the overall configuration can be modified (e.g., by replacing the cushion with a different cushion having a different stiffness). Alternatively or in addition, upper ends 108 (FIG. 14) of the seatstays 82 can be made of a resilient material in order to provide a bump stop for cushioning extreme upward travel of the seatstays 82.

The middle portion 102 of each spring member 92 is connected between the front portion 100 and the rear portion 104 and provides most of the resiliency of the spring assembly 88. The middle portion 102 defines a spring axis 109 that is oriented at a spring angle δ of about 13 degrees relative to the seatstay axis 107. Each spring member 102 is designed to have a relatively high rotational rigidity about both the vertical axis V and a longitudinal axis Lo, but a relatively low torsional rigidity about a lateral (horizontal) axis La. This is accomplished in the illustrated embodiment by dimensioning the spring member 92 to have a width W (along the lateral axis La) that is substantially larger than that a thickness T2 (normal to both the spring axis 109 and lateral axis La). In the illustrated embodiment, each spring member 92 has a width W that is about ten times larger than the thickness T2.

It is noted that the illustrated spring member 92 is substantially straight, and thus determining the spring axis 109 is relatively straightforward. In the event that a non-straight spring member is used, the spring axis is determined by a straight axis extending through the middle of the ends of the spring member.

Various features of the invention are set forth in the following claims.

1. A bicycle comprising:
front and rear wheels;
a frame supported on the front and rear wheels and including a seatstay assembly defining a seatstay axis, the seatstay assembly including a spring assembly having a spring member oriented at an angle of at least 5 degrees relative to the seatstay axis.

2. A bicycle as claimed in claim 1, wherein the spring member is oriented at an angle of 10-130 degrees relative to the seatstay axis.

3. A bicycle as claimed in claim 1, wherein the spring member is oriented at an angle of 10-100 degrees relative to the seatstay axis.

4. A bicycle as claimed in claim 1, wherein the spring member is oriented at an angle of 10-80 degrees relative to the seatstay axis.

5. A bicycle as claimed in claim 1, wherein the spring member includes a rear portion positioned higher than a front portion.

6. A bicycle as claimed in claim 1, wherein the spring member includes a rear portion positioned lower than a front portion.

7. A bicycle as claimed in claim 1, wherein a front portion of the spring assembly is secured to a seat tube of the bicycle frame.

8. A bicycle as claimed in claim 7, wherein the front portion of the spring assembly includes a concave surface receiving a portion of the seat tube.

9. A bicycle as claimed in claim 1, wherein the frame further include a seat tube supporting a saddle, wherein the spring member and seat tube define a gap, and wherein the frame further includes a resilient member positioned in the gap.

10. A bicycle as claimed in claim 9, wherein the gap is wedge-shaped and the resilient member is shaped to conform to the gap.

11. A bicycle as claimed in claim 1, wherein the spring member is a leaf spring.

12. A bicycle as claimed in claim 1, wherein the spring member has a width in a lateral direction and a thickness perpendicular to the lateral direction and generally perpendicular to a spring axis, and wherein the width is at least 4 times larger than the thickness.

13. A bicycle as claimed in claim 12, wherein the width is at least 7 times larger than the thickness.

14. A bicycle as claimed in claim 12, wherein the width is about 10 times larger than the thickness.

15. A bicycle comprising:
front and rear wheels;
a frame supported on the front and rear wheels and including a seat tube and a seatstay assembly defining a seatstay axis, the seatstay assembly including a spring member offset from the seatstay axis and non-parallel to the seatstay axis.

16. A bicycle as claimed in claim 15, wherein the seatstay assembly further includes a seatstay tube, and wherein the spring member includes a rear portion secured to the seastay tube.

17. A bicycle as claimed in claim 16, wherein the spring member includes a front portion secured to the seat tube.

18. A bicycle as claimed in claim 17, wherein the front portion is higher than the rear portion.

19. A bicycle as claimed in claim 17, wherein the rear portion is offset from the seastay axis.

20. A bicycle as claimed in claim 15, wherein the spring member is a leaf spring.
